(19) United States
(12) Patent Application Publication
(10) Pub. No.: US 2014/0143066 A1
(43) Pub. Date: May 22, 2014

(54) METHOD FOR MAXIMIZING CONVERSION VALUE FOR CONTENT PROVIDED BY A CONTENT PROVIDER

(71) Applicants: Zhen Liu, Sammamish, WA (US); Xiaodong Fu, Sammamish, WA (US)

(72) Inventors: Zhen Liu, Sammamish, WA (US); Xiaodong Fu, Sammamish, WA (US)

(21) Appl. No.: 13/679,661

(22) Filed: Nov. 16, 2012

(51) Int. Cl. G06Q 30/02

(52) U.S. Cl. 705/14.71

(57) ABSTRACT

A method for maximizing a conversion value for content provided by a content provider based on a fixed budget includes receiving a total budget of the content provider and a set of keywords for the content provider to bid on. The method further includes determining a conversion value and a cost for each keyword. The method further includes calculating a bid for each keyword based on a comparison of the conversion value for each keyword and the cost for each keyword.

### BACKGROUND

A content provider may provide one or more content items for display on a website or other online resource. The content providers may provide the content items by providing and winning bids on keywords. A keyword may be a specific term or phrase, and the content provider may bid on the keyword to provide a content item that is related to the keyword. If the content provider wins the bid for the keyword, the content provider may then provide the related content item for display on the resource.

A content provider may have a budget to spend on keyword bids over a fixed length of time. The content provider may wish to spend all of the fixed budget on keyword bids. The content provider may wish to spread the budget across all keywords such that the conversion value (e.g., a return on investment or gain on investment) on the entire budget is maximized for the content provider. For example, different content items provided for different keywords may have different values to the content provider. The return or gain on investment for the content provider may be represented as one or more of a number of user actions associated with the content item, transaction revenue associated with the content item (e.g., when a product or service is sold to a user through the content item), a number of views or impressions of the content item, or otherwise.

### SUMMARY

One implementation of the present disclosure relates to a method for maximizing a conversion value for content provided by a content provider based on a fixed budget. The conversion value may relate to a gain on investment to the content provider. The content may be provided to a user device accessing a resource. The method includes receiving a total budget from the content provider and receiving a set of keywords for bidding on by the content provider. The method further includes determining a conversion value for each keyword; wherein the conversion value is based on a conversion ratio, number of conversions, and value of each conversion. The method further includes determining a cost for each keyword, wherein the cost is based on a cost per click metric and a number of clicks. The method further includes calculating a bid for each keyword based on a comparison of the conversion value for each keyword and the cost for each keyword.

Another implementation of the present disclosure relates to a system for providing content to a user device accessing a resource by maximizing conversion value of the content based on a fixed budget. The system includes a processing circuit. The processing circuit is configured to receive a total budget from a content provider and a set of keywords for bidding on by the content provider. The processing circuit is further configured to determine a conversion value for each keyword, wherein the conversion value is based on a conversion ratio, number of conversions, and value of each conversion. The processing circuit is further configured to determine a cost for each keyword, wherein the cost at least partially includes a keyword bid. The processing circuit is further configured to calculate a bid for each keyword based on a comparison of the conversion value for each keyword and the cost for each keyword.

Another implementation of the present disclosure relates to a computer readable storage medium having instructions stored therein, the instructions being executable by one or more processors to cause the one or more processors to perform operations. The instructions include receiving a total budget from a content provider and receiving a set of keywords for bidding on by the content provider. The instructions further include determining a conversion value for each keyword, wherein the conversion value is based on a conversion ratio, number of conversions, and value of each conversion. The instructions further include determining a cost for each keyword, wherein the cost at least partially includes a keyword bid. The instructions further include calculate a bid for each keyword based on a comparison of the conversion value for each keyword and the cost for each keyword.

These implementations are mentioned not to limit or define the scope of the disclosure, but to provide an example of an implementation of the disclosure to aid in understanding thereof. Particular implementations may be developed to realize one or more of the following advantages.

### BRIEF DESCRIPTION OF THE DRAWINGS

The details of one or more implementations of the subject matter described in this specification are set forth in the accompanying drawings and the description below. Other features, aspects, and advantages of the subject matter will become apparent from the description, the drawings, and the claims.

FIG. 1 is a graph illustrating the relationship between a conversion value and a cost for a particular content in accordance with a described implementation.

FIG. 2 is a block diagram of a system in accordance with a described implementation.

FIG. 3 is a block diagram of a bid management system of the content provider of FIG. 1 in accordance with a described implementation.

FIG. 4 is a flow chart of a process for calculating keyword bids in accordance with a described implementation.

FIG. 5 is a flow chart of a process for calculating keyword bids using a feedback control parameter in accordance with a described implementation.

FIG. 6 is a flow chart of a process for calculating an initial feedback control parameter to use for calculating keyword bids in accordance with a described implementation.

FIG. 7 is a block diagram of a general architecture for a computer system that may be employed to implement various elements of the system shown in FIG. 3 in accordance with a described implementation.

### DETAILED DESCRIPTION

Referring generally to the figures, systems and methods for maximizing conversion value for content provided by a content provider are shown and described. The content provider may specify a fixed budget to spend on content keyword bids. The systems and methods described herein may determine a bid for each keyword such that the total budget is spent and the total conversion value for all provided content is maximized. The conversion value may be any metric representative of a gain on the content provider's investment (e.g., the content provider's budget) such as a number of views or impressions of the content, transaction revenue resulting from displaying the content, or otherwise.

The systems and methods described herein may be applied for a fixed budget of the content provider. Instead of determining bid amounts for each keyword independent of the content provider's budget, the total budget may be used as one factor in determining an optimal bid for each individual keyword. After determining an initial bid value for each keyword, the bids may be adjusted via a feedback control loop such that the total amount spent on each keyword bid does not exceed the total budget. This allows the content provider to maximize a conversion value of the content without exceeding a fixed amount.

Further, the systems and methods of the present disclosure allow a content provider to determine keyword bids for individual keywords instead of a group of keywords (e.g., a content group). For example, instead of providing a bid for a group of keywords that are related to one another, bids may be provided to each individual keyword of one or more groups. Therefore, if content for one keyword is better performing for the content provider than content for another keyword, the budget of the content provider may be allocated appropriately.

In one implementation of the present disclosure, conversion value may be represented as a number of conversions (e.g., a number of actions or transactions as a result of the content provided to user devices). In such a case, the conversion value may be represented as a number of conversions multiplied by the value of each conversion (assuming the content provider wishes to treat each action or transaction equally). For example, if there are ten conversions and the content provider sets a cost per action (CPA) of $5 (e.g., an amount the content provider pays per action), the conversion value is $50.

In one implementation of the present disclosure, conversion value may be represented as transaction revenue. In such a case, the conversion value may be represented as the sum of revenue from all transactions. Each transaction may have a different value based on the revenue associated with each particular content. It should be understood that the conversion value may be any other type of value such that the implicit value of each conversion is the same.

Referring to FIG. 1, in brief overview, a graph 100 illustrating a relationship between the conversion value 102 and cost 104 for a keyword or content is shown. Graph 100 includes a first possibly cost 106, a second possible cost 108, and the conversion value 102 for each of costs 104 and 106.

Still referring to FIG. 1, and in greater detail, the systems and methods for determining the keyword bids that maximize conversion value generally includes using a ratio between a conversion value and cost for each keyword. For example, each keyword may have an average return ratio which is simply a ratio of the conversion value against the cost. Ideally, a derivative of the average return ratio should be equal for all keywords that the content provider is providing bids for. In other words, each keyword in the set of keywords ideally provides the same return or rate of return to the content provider. If the derivative of the average return ratio of a first keyword is lower compared to other keywords, then that means the rate of return for a first content for the first keyword is lower than other content. Therefore, some of the budget being spent on a bid for the first keyword should be transferred to a second keyword with a higher derivative (e.g., a higher rate of return). This increases an overall rate of return for the content provider by allocating more of the budget to better performing content and keywords (e.g., the second keyword).

Referring still to FIG. 1, a first possible cost 106 and second possible cost 108 for a keyword is shown. As cost 104 increases for a keyword, conversion value 102 for the keyword also increases, but the rate of increase for conversion value 102 decreases as cost 104 increases. For example, the rate of change in conversion value at cost 108 is less than the rate of change in conversion value at cost 106. Since the rate of increase of conversion value 102 decreases, it may be more efficient to use some of cost 104 for the keyword for another keyword such that the rate of increase in conversion value for the other keyword increases. For example, spending a cost at cost 106 instead of cost 108, and allocating the difference in cost to another keyword, may maximize overall conversion value for the content provider.

Since the derivative of the average return ratio may be hard to calculate due to the dynamics of an online auction, the average return ratio itself may be used as an approximation. While the present disclosure refers to the average return ratio being equal for each keyword, it should be understood that the systems and method herein may be applied for a derivative value of the average return ratio as well.

The conversion value for a keyword may be based on a conversion ratio, number of conversions of the keyword, and the value of each conversion. The cost of each keyword may be based on a cost per click metric and a number of clicks of the content associated with the keyword. Therefore, the average return ratio for a single keyword may be represented as follows:

$$\frac{ConversionValue}{cost} = \frac{\# of conversions * V}{CPC * clicks} = \frac{CVR * V}{CPC}$$

where CVR is the conversion ratio of the keyword, V is the value of each conversion, and CPC is the cost per click metric. Therefore, since the value of each conversion is fixed, if the cost per click and conversion ratio are kept proportional across each keyword, the bids across each keyword are optimized. For a single keyword, a bid for the keyword may then be calculated as:

Bᵢ=μ*CVRᵢ

where μ is a control feedback loop parameter. This control parameter is used to limit the amount of each bid for a keyword to ensure that the total of all bids does not exceed the budget. The control parameter μ is based on the content provider's budget, a time period for which the budget is to be spent during, a daily spend rate for the keyword, and an expected spend rate for the keyword. The calculation of μ and the bids for each keyword based on the average return ratio is shown in greater detail in FIGS. 3-5.

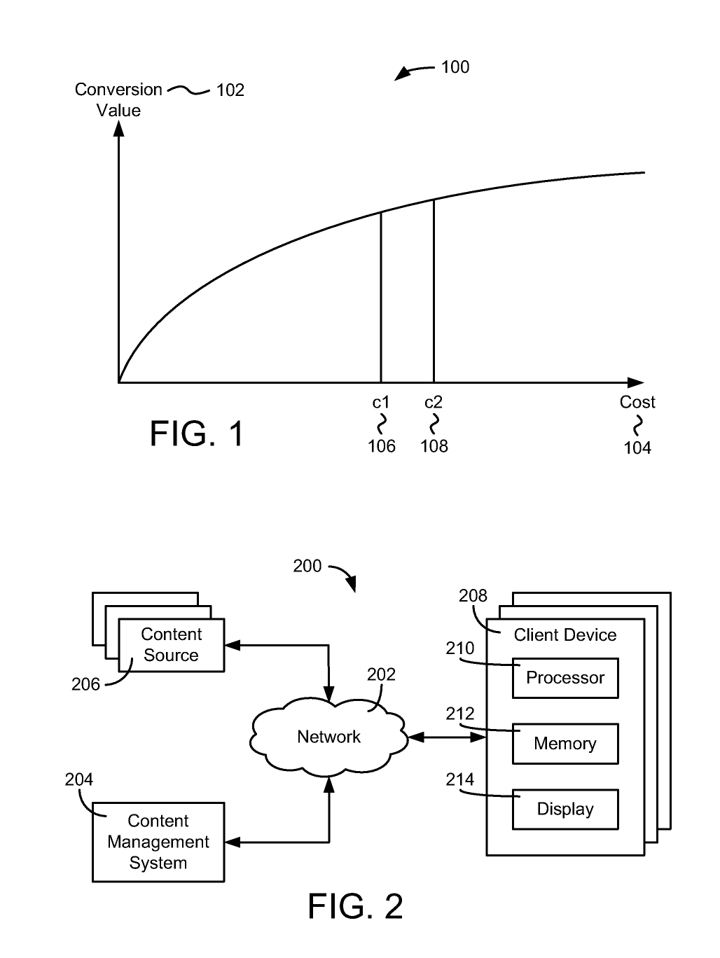

Referring now to FIG. 2, a block diagram of a system 200 in accordance with a described implementation is shown. In brief overview, system 200 may generally be a system for providing content from a content provider or content management system to a user via a client device of the user. System 200 may be used by a content provider to provide content to the user. For example, the content provider bids on keywords, a content management system awards winning bids, and the content provider may provide content to the user related to the keywords of the winning bids.

Still referring to FIG. 2, and in greater detail, system 200 may include one or more client devices 208 which communicate with other computing devices via a network 202. Client device 208 may execute a web browser or other application to retrieve content from other devices via network 202. For example, client device 208 may communicate with any number of content sources 206 (e.g., content providers). Content sources 206 may provide resource data and/or other content (e.g., text documents, PDF files, and other forms of electronic documents, as well as other online content such as applications, video, audio, etc.) to a client device 208. In some implementations, system 200 may also include a content management system 204 configured to manage content provided to client devices 208 by content sources 206 or another source connected to network 202.

Still referring to FIG. 2, network 202 may be any form of computer network that relays information between content management system 204, content sources 206, and client devices 208. For example, network 202 may include the Internet and/or other types of data networks, such as a local area network (LAN), a wide area network (WAN), a cellular network, satellite network, or other types of data networks. Network 202 may also include any number of computing devices (e.g., computers, servers, routers, network switches, etc.) that are configured to receive and/or transmit data within network 202. Network 202 may further include any number of hardwired and/or wireless connections. For example, client device 208 may communicate wirelessly (e.g., via WiFi, cellular, radio, etc.) with a transceiver that is hardwired (e.g., via a fiber optic cable, a CATS cable, etc.) to other computing devices in network 202.

Still referring to FIG. 2, client device 208 may be any number of different types of electronic devices configured to communicate via network 202 (e.g., a laptop computer, a desktop computer, a mobile phone or other mobile device, a tablet computer, a smartphone, a digital video recorder, a set-top box for a television, a video game console, combinations thereof, etc.). Client device 208 is shown to include a processor 210 and memory 212 (i.e., a processing circuit). Memory 212 may store machine instructions that, when executed by processor 210 to cause processor 210 to perform one or more of the operations described herein. Processor 210 may include a microprocessor, ASIC, FPGA, etc., or combinations thereof. Memory 212 may include, but is not limited to, electronic, optical, magnetic, or any other storage or transmission device capable of providing processor 210 with program instructions. Memory 212 may include a floppy disk, CD-ROM, DVD, magnetic disk, memory chip, ROM, RAM, EEPROM, EPROM, flash memory, optical media, or any other suitable memory from which processor 210 can read instructions. The instructions may include code from any suitable computer programming language such as, but not limited to, C, C++, C#, Java, JavaScript, Perl, HTML, XML, Python, and Visual Basic.

Still referring to FIG. 2, client device 208 may include one or more user interface devices. A user interface device may be any electronic device that conveys data to a user by generating sensory information (e.g., a visualization on a display, one or more sounds, etc.) and/or converts received sensory information from a user into electronic signals (e.g., a keyboard, a mouse, a pointing device, a touch screen display, a microphone, etc.). The one or more user interface devices may be internal to the housing of client device 208 (e.g., a built-in display, microphone, etc.) or external to the housing of client device 208 (e.g., a monitor or speaker connected to client device 208, etc.), according to various implementations. For example, client device 208 may include an electronic display 214, which displays resources (e.g., websites) and other data received from content sources 206 and/or content management system 204.

Still referring to FIG. 2, content sources 206 may be one or more electronic devices connected to network 202 that provide content to client devices 208. For example, content sources 206 may be computer servers (e.g., FTP servers, file sharing servers, web servers, etc.) or combinations of servers (e.g., data centers, cloud computing platforms, etc.). Content may include, but is not limited to, resource data, a text file, a spreadsheet, images, and other forms of electronic content.

According to various implementations, content sources 206 may provide resource data that includes one or more content tags to client devices 208. In general, a content tag may be any piece of resource code associated with including content with a resource. According to various implementations, a content tag may define a slot on a resource for additional content, a slot for out of page content (e.g., an interstitial slot), whether content should be loaded asynchronously or synchronously, whether the loading of content should be disabled on the resource, whether content that loaded unsuccessfully should be refreshed, the network location of a content source that provides the content (e.g., content sources 206, content management system 204, etc.), a network location (e.g., a URL) associated with clicking on the content, how the content is to be rendered on a display, one or more keywords used to retrieve the content, and other functions associated with providing additional content with a resource. For example, content sources 206 may provide resource data that causes client devices 208 to retrieve content from content management system 204. In another implementation, the content may be selected by content management system 204 and provided by a content source 206 as part of the resource data sent to client device 208.

Still referring to FIG. 2, similar to content sources 206, content management system 204 may be one or more electronic devices connected to network 202 that provide content to client devices 208. Content management system 204 may be a computer server (e.g., FTP servers, file sharing servers, web servers, etc.) or a combination of servers (e.g., a data center, a cloud computing platform, etc.). Content management system 204 may include a processing circuit including a processor and memory as described above.

Content selected by content management system 204 may be provided to a client device 208 by content sources 206 or content management system 204. For example, content management system 204 may select content from content sources 206 to be included with a resource served by a content source 206. In another example, content management system 204 may provide the selected content to a client device 208. In some implementations, content management system 204 may select content stored in memory 212 of a client device 208. The content may be selected based on an interest profile of the user, in one implementation. For example, content management system 204 may select content such that the topic or subject of the content is a match with a topic or subject associated with the interest profile.

An identifier associated with client device 208 and/or a user of client device 208 may be used to help select content. For example, the identifier may be used to identify an interest profile, and the interest profile may be used to select content. The identifier may refer to any form of data that may be used to represent a user that has chosen to receive relevant content selected by content management system 204. In some implementations, an identifier may be associated with one or more client identifier that identifies a client device (e.g., mobile device, desktop computer, laptop computer, PDA, smart phone, computer network, etc.) to content management system 204 or may itself be the client identifier.

For situations in which the systems and method discussed herein collect personal information about users, or may make use of personal information, the users may be provided with an opportunity to control whether programs or features may collect personal information (e.g., information about a user's social network, social actions or activities, a user's preferences, or a user's current location), or to control whether and/or how to receive content from the content management system that may be more relevant to the user. In addition, certain data may be anonymized in one or more ways before it is stored or used by content management system 204, so that personally identifiable information is removed when generating monetizable parameters (e.g., monetizable demographic parameters). For example, a user's identity may be anonymized so that no personally identifiable information can be determined for the user, or a user's geographic location may be generalized where location information is obtained (such as to a city, ZIP code, or state level), so that a particular location of the user cannot be determined. Thus, the user may have control over how information is collected about him or her and used by content management system 204.

The content provided by content sources 206 may be advertisements. The advertisements may be image advertisements, flash advertisements, video advertisements, text-based advertisements, or any combination thereof. It should be understood that while the present disclosure is implemented for advertisements, the type of advertisement or other content displayed via a client device 208 may vary according to various implementations.

System 200 is illustrated as an example environment for use with the systems and methods of the present disclosure; in various implementations, system 200 may include more or less systems and modules for use with the systems and methods of the present disclosure.

Referring now to FIG. 2 and FIG. 3, a bid management system 302 of a content source 206 is shown and described in accordance with a described implementations. Content management system 204, in one implementation, may select a content source 206 to provide content to client device 208 as described with reference to FIG. 2. Content management system 204 may generally receive keyword bids from content sources 206 to make such selections. For example, content management system 204 may receive a content request from client device 208. The content request may be associated with one or more keywords. The one or more keywords may represent a topic or user interest associated with the content request (e.g., for a content request for a sports website, examples of keywords may include “sports,” “baseball,” “football,” and so on). Content management system 204 may then review keyword bids provided by one or more content sources 206 and select a winning bid. The content source with the winning bid may then provide content relating to the keyword to client device 208 and provide payment to content management system 204 or another system when the content is displayed or interacted with.

Bid management system 302 may receive a set of keywords 304 and provide a set of keyword bids 306 to content management system 204. Content source 206 may include an interface 308 for sending and receiving information from content management system 204 and other components of system 200. Interface 308 may be configured to facilitate communications, either via a wired connection or wirelessly, with the components of system 200.

Referring now to FIG. 3, bid management system 302 may include budget information 310 and keyword data 312 that may be used to determine keyword bids. Budget information 310 may include information about the content source's total budget available to spend on keyword bids and a fixed period of time in which to spend the budget. For example, content source 206 may specify a fixed budget to spend on keyword bids over a period of time such as one month.

Referring still to FIG. 3, keyword data 312 may include information relating to keyword performance (e.g., the performance of content that has been provided by content source 206 when the content was provided for display to a user based on the keyword). Keyword data 312 may be tracked by content source 206 or received from a content management system 204 or other module of system 200. In one implementation, keyword data 312 may include a conversion ratio or predicted conversion ratio for each keyword. The conversion ratio or predicted conversion ratio is a ratio of the number of times content is provided to a user compared to the number of times the user interacts with the content. The number of times the user interacts with the content may be based on a number of clicks of the content, the number of views of the content, a total revenue associated with user interaction with the content, or any other type of measurement of successful interaction between the content and the user. Keyword data 312 may include a predicted conversion ratio for a keyword based on previous history of content associated with the keyword.

Still referring to FIG. 3, keyword bid module 314 may be configured to receive budget information 310 and keyword data 312 (e.g., predicted conversion ratios for each keyword) and to calculate a bid for each keyword to provide to content management system 204. Referring again to FIG. 1, the calculation of the bid for each keyword may include calculating a bid B, for a keyword using the following formula:

Bᵢ=μ*CVRᵢ

where CVR is the predicted conversion ratio received from keyword data 312 and where μ is a control feedback loop parameter as described above.

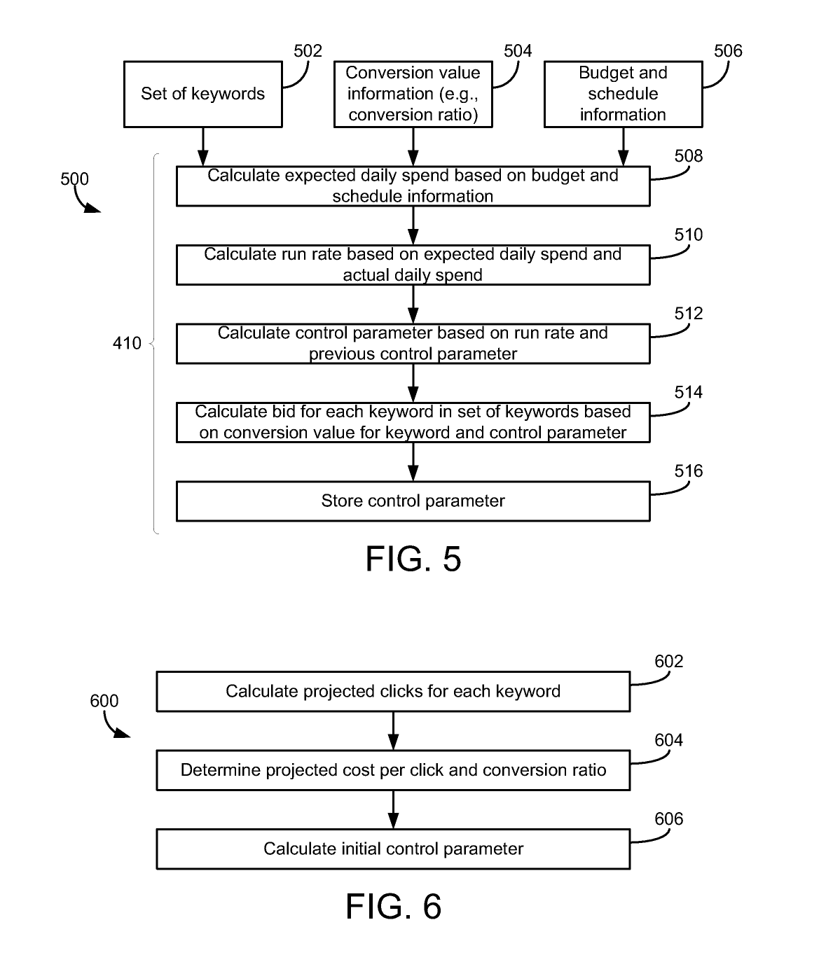

Keyword bid module 314 may further be configured to calculate the control parameter μ as part of the keyword bid calculation. The control parameter μ may be calculated based on budget information 310 and a previous control parameter value. In one implementation, the control parameter μ may be calculated based on the total budget of content source 206, a period of time in which to spend the budget (e.g., one month), and a portion of the total budget to spend for a specified portion of the period of time (e.g., for a time period of 20 days, spend 5% of the total remaining budget for the next day). The budget information may generally be used to calculate a run rate that is representative of a difference between an amount of the budget the content source is willing to spend against an expected amount the content provider expects to pay for keyword bids based on the current keyword bid values of the content provider. This run rate may then be used to adjust the control parameter μ. An example calculation of the control parameter μ and keyword bid using the budget information is shown in greater detail in FIG. 5.

The bid management system of FIG. 3 is shown as part of a content source 206. However, in other implementations, the bid management system and activities thereof may be executed by a content management system or another module of system 200. For example, content source 206 may provide budget information to another module of system 200 such as content management system 204, and content management system 204 may calculate keyword bids for content source 206 based on the budget information and keyword data either stored by content management system 204 or received from content source 206. It should be understood that the methods executable by bid management system 302 may be executed as part of a content source 206 activity or as part of an activity of any other module of system 200.

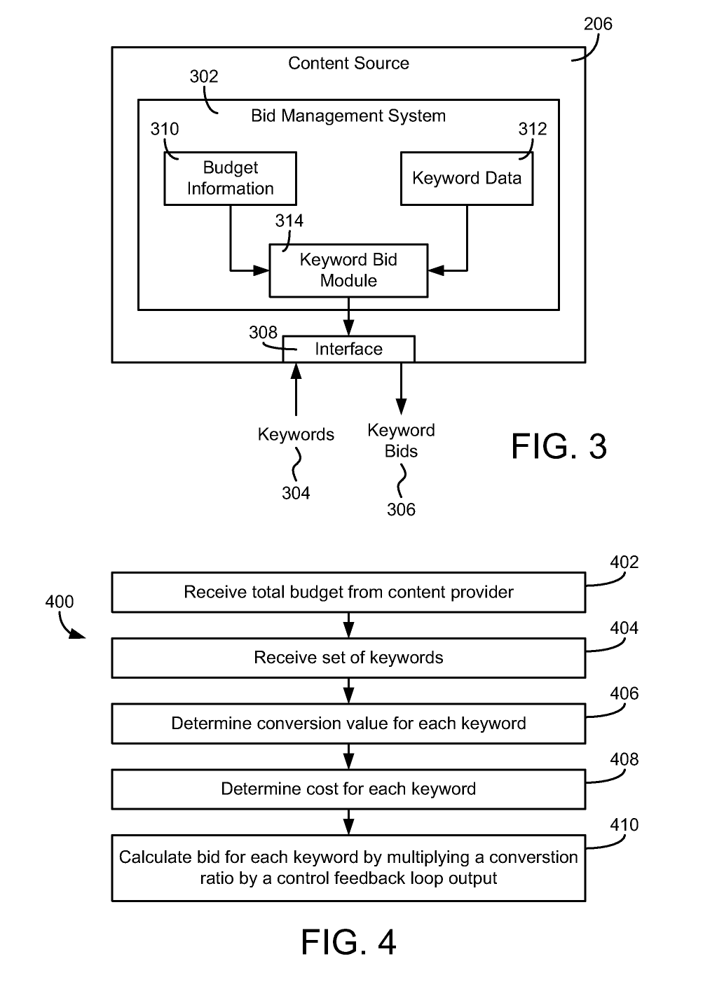

Referring now to FIG. 4, a flow chart of a process 400 for calculating keyword bids is shown in accordance with a described implementation. In brief overview, process 400 may include receiving a total budget from a content provider (block 402), receiving a set of keywords (block 404), determining a conversion value for each keyword (block 406), determining a cost for each keyword (block 408), and calculating a bid for each keyword (block 410). Process 400 may be executed by, for example, a bid management system 302 of a content source 206. In other implementations, process 400 may be executed by a content management system or other system configured to determine keyword bids for a content provider based on a fixed budget.

Still referring to FIG. 4, and in greater detail, process 400 may include receiving a total budget from the content provider (block 402). The total budget represents a total amount the content provider is willing to spend on displaying content to a user. Process 400 further includes receiving a set of keyword for bidding on by the content provider (block 404). The set of keywords may be provided by, for example, a content management system configured to select winning bids.

Referring still to FIG. 4, process 400 may further include determining a conversion value for each keyword (block 406) and a cost for each keyword (block 408). The conversion value may be, for example, a predicted conversion value for content for a particular keyword. The cost for each keyword may be, for example, a predicted number of clicks and a cost per click of the content.

Referring still to FIG. 4, process 400 may further include calculating a bid for each keyword based on a comparison of the conversion value for each keyword and the cost for each keyword (block 410). As discussed with reference to FIG. 1, an average return ratio of the conversion value and cost may be desired to be kept equal across each keyword in the set of keywords. In one implementation, the comparison may be made by calculating an average return ratio between the conversion value and cost for each keyword. Bids may then be calculated for the keywords by keeping the average return ratio for each keyword roughly equivalent to one another.

Referring now to FIG. 5, a flow chart of a process 500 for calculating keyword bids using a feedback control parameter is shown in accordance with a described implementation. In other words, process 500 completes the activities of block 410 of FIG. 4. Process 500 may be executed by a bid management system 302 and more specifically a keyword bid module 314 configured to calculate keyword bids for an optimal bidding strategy of the content provider.

Referring still to FIG. 5, process 500 may include receiving various parameters for calculating the keyword bids. For example, process 500 includes receiving a set of keywords (block 502) to bid on. Process 500 may further include receiving conversion value information for each keyword, such as a conversion ratio for each keyword (block 504). Process 500 may further include receiving budget and schedule information (block 506). The information at block 506 may include the total budget of the content provider, a time period in which to spend the budget, and a portion of the total budget to spend for a specified portion of the time period.

Referring still to FIG. 5, process 500 may include calculating an expected daily spend based on the budget and schedule information (block 508). The expected daily spend may be an amount (e.g., a portion of the budget) that the content provider expects to spend over one day. At block 510, a run rate may be calculated based on the expected daily spend calculated in block 508 and an actual daily spend of the content provider (e.g., the amount per day that the content provider is paying based on the keyword bids). The run rate may be calculated as a ratio of the actual daily spend over the expected daily spend. Ideally, the run rate should be equal to one as the expected and actual daily spend should be equal to each other.

Referring still to FIG. 5, process 500 may include calculating a control parameter based on a previous control parameter and the run rate (block 512). The calculation at block 512 may be or include an adjustment on the previous control parameter using the run rate. For example, in one implementation, the control parameter may be calculated using the following equations:

if run rate>1,then μ=μ(1−ε)

if run rate<1,then μ=μ(1+ε).

If the run rate is greater than one, then the actual daily spend is greater than the expected daily spend; therefore μ should be decreased in order to decrease the amount spent on a keyword bid. If the run rate is greater than one, then the expected daily spend is greater than the actual daily spend; therefore μ should be increased since there is room in the budget to increase keyword bids. ε may be a small fixed value selected by the content provider and represent a small incremental increase in a keyword bid relative to the budget. For example, ε may be assigned a value of 5% (e.g., for each calculation of the control parameter μ, it is increased or decreased by 5%).

In another implementation, the control parameter calculated at block 512 may be the control feedback loop output used in block 410 of FIG. 4. For example, the control parameter calculation at block 512 may include using a proportional controller (P controller) calculation as follows:

μ=μ(1+p(1−run rate)).

Referring still to FIG. 5, process 500 may include calculating a bid for each keyword (block 514) based on the conversion value of the keyword (received at block 504) and the control parameter (received at block 512). The calculation may be represented as:

Bᵢ=μ*CVRᵢ

where Bᵢ is the keyword bid for the i^{th} keyword in the set of keywords and CVR, is a predicted conversion ratio for the keyword. At block 516, the control parameter μ may be stored for use in the next calculation of the control parameter.

Referring generally to the process of FIG. 5, a process for calculating a control parameter based in part on a previous control parameter is described. However, if there is not previous control parameter value, the control parameter may need to be initialized first.

Referring now to FIG. 6, a flow chart of a process 600 for calculating an initial feedback control parameter is shown in accordance with a described implementation. In brief overview, process 600 may include calculating projected clicks for each keyword (block 602), determining a projected cost per click and a projected conversion ratio (block 604), and calculating an initial control parameter (block 606).

The calculation of the initial value of the control parameter μ may include solving the following equation:

projected CPCᵢ=μ*pCVRᵢ

where the projected CPC is the projected cost per click for the keyword and pCVR is the predicted conversion ratio for the keyword. The predicted conversion ratio for the keyword may be provided at, for example, block 504 of process 500. For the projected cost per click, the following equation holds:

Σprojected CPCᵢ*projected clicksᵢ=budget.

In other words, the total spent on an individual keyword i is the projected clicks associated with the keyword times the projected cost per click associated with the keyword, and the sum of spend on each keyword should equal the total budget. Estimating the projected clicks for a keyword can result in calculating a projected cost per click for each keyword, and therefore calculating the control parameter.

Referring still to FIG. 6, process 600 may include calculating the projected clicks for each keyword (block 602). In one implementation, a linear extrapolation traffic estimation may be used to calculate the projected clicks. For a keyword kᵢ the content provider may have a number of clicks cᵢ and bid bᵢ from the previous day (or another previous period of time). Linear extrapolation may be used using the values cᵢ and bᵢ as follows:

$$projected {clicks}_{i} = μ * {pcvr}_{i} * \frac{{c}_{i}}{{b}_{i}} .$$

In another implementation, a linear interpolation method may be used in block 602. If there are two or more sets of data points, then an upper set of data points and a lower set of data points (e.g., a first click and bid (cᵢ₁ and bᵢ₁) and a second click and bid (cᵢ₂ and bᵢ₂)) may be selected. Each set of data points may include a number of clicks and a bid amount for a given keyword for a given time frame. The upper and lower set of data points may represent a highest and lowest number of clicks and bids associated with the keyword. Linear interpolation may then be used as a curve fitting method that takes a bid amount and corresponds it with a projected click amount (see block 606 for further mathematical representation of the calculation).

Referring still to FIG. 6, process 600 may include determining a projected cost per click and conversion ratio (block 604). Process 600 may then include calculating the initial control parameter (block 606) using the equation above.

In one implementation, if a linear extrapolation method is used as described above, the calculation of the control parameter μ may be represented as:

$$μ = \sqrt{\frac{B}{{pcvr}_{i}^{2} * \frac{{c}_{i}}{{b}_{i}}}} .$$

In another embodiment, if a linear interpolation method is used as described above, the calculation of the control parameter μ may be represented as:

$$A * μ + c * {μ}^{2} = budget , \\ where A = {\sum }_{i} \frac{{b}_{i 1} * {c}_{i 2} - {b}_{i 2} * {c}_{i 1}}{{b}_{i 1} - {b}_{i 2}} * {pcvr}_{i} and$$

$$C = {\sum }_{i} \frac{{c}_{i 1} - {c}_{i 2}}{{b}_{i 1} - {b}_{i 2}} * {pcvr}_{i}^{2} ,$$

where cᵢ₁ and bᵢ₁ are data points for a first click and first bid and cᵢ₂ and bᵢ₂ are data points for a second click and second bid.

The process of FIG. 6 may be revised if the amount of history data for initializing the control parameter is insufficient. For example, if a particular keyword has low traffic, there may not be enough history data for the keyword to use as part of the calculation of an initial control parameter. In such a scenario, process 600 may include determining that the projected clicks for the keyword is zero.

If a keyword is “new” and there is insufficient statistics for the keyword, a trial run may be used for the keyword. If, for example, 50% of keywords in a particular content group were “created” in the last seven days or another specified timeframe, then a trial run may be used to collect a first set of data points for the new keywords. In the trial run, for the new keywords, a default target position or value may be assigned to the keywords.

In the implementations of FIGS. 4-6, there may be keywords with few or no conversions. Therefore, the projected conversion ratio for the keyword will be very low, the bid for each keyword will be consistently low, and the content associated with the keywords will not get any impressions or views. In such a situation, the bid for the keywords in question may be periodically increased without regard to the average return ratio as an attempt to create impressions or views for the keyword. The resulting traffic and data may then be used for the keyword normally in the future.

In one implementation of the present disclosure, the systems and methods of FIGS. 1-6 may be used for floodlight tags as the keywords. Floodlight tags may be tags that are configured to measure and report conversions for content on a given resource. The content provider may define a set of floodlight tags that should be included as part of the set of keywords to bid on. The number of conversions or transaction revenue may then be calculated based on the data from the floodlight tags. A predicted conversion ratio may be the sum of predicted conversion ratios of each floodlight tag.

In one implementation, in addition to using the total budget constraint as described in FIGS. 1-6, the content provider may further specify a maximum average return ratio value. For example, if the content provider wishes to maximize the total number of conversions for a given budget, the content provider may specify a maximum cost per action that is not to be exceeded when determining keyword bids. As another example, if the content provider wishes to maximize total revenue for a given budget, the content provider may specify a maximum revenue share value not to be exceeded for a single keyword.

In one implementation, a content provider may place a different weight or value on each conversion. In such an implementation, the content provider may place a higher weight or value on a conversion related to one particular keyword or keyword group compared to other keywords or keyword groups. In such an implementation, the average return ratio may be represented as:

$$\frac{ConversionValue}{cost} = \frac{CVR * ( \frac{{Conv}_{F 1}}{TotalConv} {weight}_{F 1} + \frac{{Conv}_{F 2}}{TotalConv} {weight}_{F 2} ) * V}{CPC} .$$

In other words, for a first portion of the total number of conversions

$$\frac{{Conv}_{F 1}}{TotalConv}$$

and a second portion of the total number of conversions

$$\frac{{Conv}_{F 2}}{TotalConv} ,$$

a weight is assigned for each such conversion by the content provider. The weight for a particular keyword i may be represented as:

$${weight}_{i} = ( \frac{{Conv}_{F 1}}{TotalConv} {weight}_{F 1} + \frac{{Conv}_{F 2}}{TotalConv} {weight}_{F 2} )$$

Further, the content provider may use the weights to create a mixture of number of conversions and transaction revenue to use as the conversion value for the algorithms described herein. For example, a weight for a particular keyword may be calculated as follows:

$${weight}_{i} = ( \frac{{Conv}_{F 1}}{TotalConv} {CPA}_{F 1} + \frac{{Conv}_{F 2}}{TotalConv} {AvgRevenue}_{F 2} ) .$$

The weight for keyword i is calculated by taking a first portion of the total conversions

$$( \frac{{Conv}_{F 1}}{TotalConv} )$$

multiplied by a cost per action for those conversions plus a second portion of the total conversions

$$( \frac{{Conv}_{F 2}}{TotalConv} )$$

times a revenue associated with those conversions.

The systems and methods of the present disclosure are described with reference to maximizing conversion value. In an alternative implementation, the systems and methods herein may be used to maximize transaction revenue. As described with reference to FIG. 1, the average return ratio should be kept equal across each keyword. The average return ratio may be represented as:

$$\frac{ConversionValue}{cost} = \frac{CVR * average revenue}{CPC} .$$

Therefore, if the cost per click is kept proportional to the conversion ratio times the average revenue for each keyword, the systems and methods herein can be used to determine optimal keyword bids. Therefore, a bid bᵢ for a keyword i may be represented as:

Bᵢ=μ*CVRᵢ*average revenue,

wherein the average revenue for the keyword in the previous evaluation period (e.g., one day) is used.

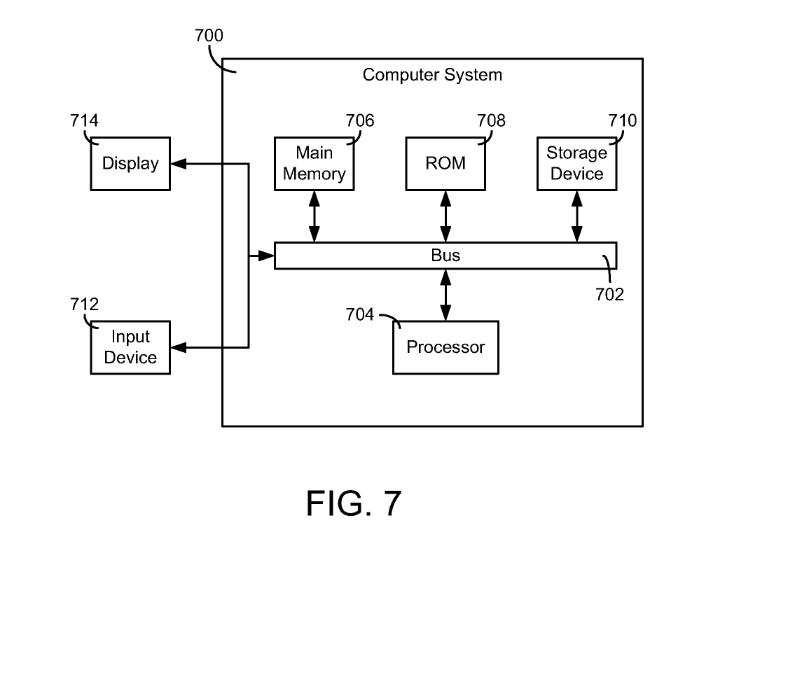

Referring now to FIG. 7, a block diagram of a general architecture for a computer system 700 that may be employed to implement various elements of the system shown in FIG. 3 is shown in accordance with a described implementation. Computer system 700 may be used to implements the systems and methods described herein, including, for example, bid management system 302.

Referring still to FIG. 7, computer system 700 may include a bus 702 or other communication component for communicating information and a processor 704 or other processing circuit coupled to bus 702 for processing information. Processor 704 may be implemented as a general purpose processor, an application specific integrated circuit (ASIC), one or more field programmable gate arrays (FPGAs), a group of processing components, or other suitable electronic processing components.

Referring still to FIG. 7, computer system 700 may include main memory 706, such as a random access memory (RAM) or other dynamic storage device, coupled to bus 702 for storing information, and instructions to be executed by processor 704. Main memory 706 may also be used for storing position information, temporary variables, or other intermediate information during execution of instructions by processor 704. Main memory 706 may be or include non-transient volatile memory or non-volatile memory.

Referring still to FIG. 7, computer system 700 may further include a read only memory (ROM) 708 or other static storage device coupled to bus 702 for storing static information and instructions for processor 704. A storage device 710, such as a solid state device, magnetic disk, or optical disk, may be coupled to bus 702 for persistently storing information and instructions.

Computing system 700 may be coupled via bus 702 to a display 714, such as a liquid crystal display, or active matrix display, for displaying information to a user. An input device 712, such as a keyboard including alphanumeric and other keys, may be coupled to bus 702 for communicating information and command selections to processor 704. In another implementation, input device 712 has a touch screen display 714. Input device 712 may include a cursor control, such as a mouse, trackball, or cursor direction keys, for communicating direction information and command selections to processor 704 and for controlling cursor movement on display 714.

According to various implementations, the processes described herein can be implemented by computing system 700 in response to processor 704 executing an arrangement of instructions contained in main memory 706. Such instructions can be read into main memory 706 from another computer-readable medium, such as storage device 710. Execution of the arrangement of instructions contained in main memory 706 causes computing system 700 to perform the illustrative processes described herein. One or more processors in a multi-processing arrangement may also be employed to execute the instructions contained in main memory 706. In alternative implementations, hardwired circuitry may be used in place of or in combination with software instructions to effect illustrative implementations. Thus, implementations are not limited to any specific combination of hardware circuitry and software.

Although an example computing system has been described with reference to FIG. 7, implementations of the subject matter and the functional operation described in this specification can be implemented in other types of digital electronic circuitry, or in computer software, firmware, or hardware, including the structures disclosed in this specification and their structural equivalents, or in combinations of one or more of them.

Implementations of the subject matter and the operations described in this specification may be implemented in digital electronic circuitry, or in computer software, firmware, or hardware, including the structures disclosed in this specification and their structural equivalents, or in combinations of one or more of them. Implementations of the subject matter described in this specification may be implemented as one or more computer programs, i.e., one or more modules of computer program instructions, encoded on one or more computer storage medium for execution by, or to control the operation of, data processing apparatus. Alternatively or in addition, the program instructions may be encoded on an artificially-generated propagated signal (e.g., a machine-generated electrical, optical, or electromagnetic signal) that is generated to encode information for transmission to suitable receiver apparatus for execution by a data processing apparatus. A computer storage medium may be, or be included in, a computer-readable storage device, a computer-readable storage substrate, a random or serial access memory array or device, or a combination of one or more of them. Moreover, while a computer storage medium is not a propagated signal, a computer storage medium may be a source or destination of computer program instructions encoded in an artificially-generated propagated signal. The computer storage medium may also be, or be included in, one or more separate components or media (e.g., multiple CDs, disks, or other storage devices). Accordingly, the computer storage medium is both tangible and non-transitory.

The operations described in this disclosure may be implemented as operations performed by a data processing apparatus on data stored on one or more computer-readable storage devices or received from other sources.

The term “client or “server” include all kinds of apparatus, devices, and machines for processing data, including by way of example a programmable processor, a computer, a system on a chip, or multiple ones, or combinations, of the foregoing. The apparatus may include special purpose logic circuitry, e.g., a field programmable gate array (FPGA) or an application-specific integrated circuit (ASIC). The apparatus may also include, in addition to hardware, code that creates an execution environment for the computer program in question (e.g., code that constitutes processor firmware, a protocol stack, a database management system, an operating system, a cross-platform runtime environment, a virtual machine, or a combination of one or more of them). The apparatus and execution environment may realize various different computing model infrastructures, such as web services, distributed computing and grid computing infrastructures.

The systems and methods of the present disclosure may be completed by any computer program. A computer program (also known as a program, software, software application, script, or code) may be written in any form of programming language, including compiled or interpreted languages, declarative or procedural languages, and it may be deployed in any form, including as a stand-alone program or as a module, component, subroutine, object, or other unit suitable for use in a computing environment. A computer program may, but need not, correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform actions by operating on input data and generating output. The processes and logic flows may also be performed by, and apparatus may also be implemented as, special purpose logic circuitry (e.g., an FPGA or an ASIC).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data (e.g., magnetic, magneto-optical disks, or optical disks). However, a computer need not have such devices. Moreover, a computer may be embedded in another device (e.g., a mobile telephone, a personal digital assistant (PDA), a mobile audio or video player, a game console, a Global Positioning System (GPS) receiver, or a portable storage device (e.g., a universal serial bus (USB) flash drive), etc.). Devices suitable for storing computer program instructions and data include all forms of non-volatile memory, media and memory devices, including by way of example semiconductor memory devices (e.g., EPROM, EEPROM, and flash memory devices; magnetic disks, e.g., internal hard disks or removable disks; magneto-optical disks; and CD-ROM and DVD-ROM disks). The processor and the memory may be supplemented by, or incorporated in, special purpose logic circuitry.

To provide for interaction with a user, implementations of the subject matter described in this specification may be implemented on a computer having a display device (e.g., a CRT (cathode ray tube), LCD (liquid crystal display), OLED (organic light emitting diode), TFT (thin-film transistor), or other flexible configuration, or any other monitor for displaying information to the user and a keyboard, a pointing device, e.g., a mouse, trackball, etc., or a touch screen, touch pad, etc.) by which the user may provide input to the computer. Other kinds of devices may be used to provide for interaction with a user as well; for example, feedback provided to the user may be any form of sensory feedback (e.g., visual feedback, auditory feedback, or tactile feedback), and input from the user may be received in any form, including acoustic, speech, or tactile input. In addition, a computer may interact with a user by sending documents to and receiving documents from a device that is used by the user; for example, by sending web pages to a web browser on a user's client device in response to requests received from the web browser.

Implementations of the subject matter described in this disclosure may be implemented in a computing system that includes a back-end component (e.g., as a data server), or that includes a middleware component (e.g., an application server), or that includes a front-end component (e.g., a client computer) having a graphical user interface or a Web browser through which a user may interact with an implementation of the subject matter described in this disclosure, or any combination of one or more such back-end, middleware, or front-end components. The components of the system may be interconnected by any form or medium of digital data communication (e.g., a communication network). Examples of communication networks include a LAN and a WAN, an inter-network (e.g., the Internet), and peer-to-peer networks (e.g., ad hoc peer-to-peer networks).

While this specification contains many specific implementation details, these should not be construed as limitations on the scope of any disclosures or of what may be claimed, but rather as descriptions of features specific to particular implementations of particular disclosures. Certain features that are described in this disclosure in the context of separate implementations may also be implemented in combination in a single implementation. Conversely, various features that are described in the context of a single implementation may also be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

The features disclosed herein may be implemented on a smart television module (or connected television module, hybrid television module, etc.), which may include a processing circuit configured to integrate internet connectivity with more traditional television programming sources (e.g., received via cable, satellite, over-the-air, or other signals). The smart television module may be physically incorporated into a television set or may include a separate device such as a set-top box, Blu-ray or other digital media player, game console, hotel television system, and other companion device. A smart television module may be configured to allow viewers to search and find videos, movies, photos and other content on the web, on a local cable TV channel, on a satellite TV channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television module may be configured to provide a home screen or top level screen including icons for a plurality of different applications, such as a web browser and a plurality of streaming media services (e.g., Netflix, Vudu, Hulu, etc.), a connected cable or satellite media source, other web “channels”, etc. The smart television module may further be configured to provide an electronic programming guide to the user. A companion application to the smart television module may be operable on a mobile computing device to provide additional information about available programs to a user, to allow the user to control the smart television module, etc. In alternate implementations, the features may be implemented on a laptop computer or other personal computer, a smartphone, other mobile phone, handheld computer, a tablet PC, or other computing device.

Thus, particular implementations of the subject matter have been described. Other implementations are within the scope of the following claims. In some cases, the actions recited in the claims may be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method for maximizing a conversion value for content provided by a content provider based on a fixed budget, the conversion value relating to a gain on investment to the content provider, the content to be provided to a user on a resource, comprising:
receiving a total budget from the content provider;
receiving a set of keywords;
determining a conversion value for each keyword, wherein the conversion value is based on a conversion ratio, number of conversions, and value of each conversion;
determining a cost for each keyword, wherein the cost is based on a cost per click metric and a number of clicks; and
calculating a bid for each keyword by multiplying the conversion ratio by a control feedback loop output.

2. The method of claim 1, wherein a total amount spent on bids for all keywords is equal to the total budget.

3. The method of claim 1, wherein calculating a bid for each keyword comprises:
calculating an average return ratio between the conversion value and the cost for each keyword; and
determining a bid for each keyword such that the average return ratio value is equal for each keyword.

4. The method of claim 3, wherein keeping the average return ratio equal for each keyword comprises keeping the conversion ratio proportional to the cost per click for each keyword.

5. The method of claim 4, wherein the control feedback loop output is based on:
the total budget and a period of time in which to spend the budget;
a portion of the total budget to spend for a specified portion of the period of time; and
the previous control feedback loop output.

6. The method of claim 5, wherein the period of time is measured in units of days and wherein the specified portion of the period of time is one day.

7. The method of claim 5, wherein the control feedback loop output is initialized based on a projected conversion ratio and a projected cost per click of the keyword.

8. The method of claim 3, further comprising:
receiving a maximum average return ratio from the content provider;
wherein the average return ratio is kept below the maximum average return ratio when calculating the bid for each keyword.

9. The method of claim 1, wherein each conversion is weighted.

10. A system for providing content to a user of a resource by maximizing conversion value of the content based on a fixed budget; the system comprising a processing circuit configured to:
receive a total budget from a content provider;
receive a set of keywords;
determine a conversion value for each keyword, wherein the conversion value is based on a conversion ratio, number of conversions, and value of each conversion;
determine a cost for each keyword, wherein the cost at least partially includes a keyword bid; and
calculate a bid for each keyword by multiplying the conversion ratio by a control feedback loop output.

11. The system of claim 10, wherein a total amount spent on bids for all keywords is equal to the total budget.

12. The system of claim 10, wherein calculating a bid for each keyword comprises:
calculating an average return ratio between the conversion value and the cost for each keyword; and
determining a bid for each keyword such that the average return ratio value is equal for each keyword.

13. The system of claim 12, wherein keeping an average return ratio between the conversion value and the cost comprises keeping the conversion ratio proportional to the bid for each keyword.

14. The system of claim 13, wherein the control feedback loop output is based on:
the total budget;
a period of time in which to spend the budget;
a portion of the total budget to spend for a specified portion of the period of time; and
the previous control feedback loop output.

15. A computer readable storage medium having instructions stored therein, the instructions being executable by one or more processors to cause the one or more processors to perform operations, comprising:
receiving a total budget from a content provider;
receiving a set of keywords;
determining a conversion value for each keyword, wherein the conversion value is based on a conversion ratio, number of conversions, and value of each conversion;
determining a cost for each keyword, wherein the cost at least partially includes a keyword bid; and
calculating a bid for each keyword by multiplying the conversion ratio by a control feedback loop output.

16. The computer readable storage medium of claim 15, wherein a total amount spent on bids for all keywords is equal to the total budget.

17. The computer readable storage medium of claim 15 wherein calculating a bid for each keyword comprises:
calculating an average return ratio between the conversion value and the cost for each keyword; and
determining a bid for each keyword such that the average return ratio value is equal for each keyword.

18. The computer readable storage medium of claim 17, wherein keeping the average return ratio equal for each keyword comprises keeping the conversion ratio proportional to the cost per click for each keyword.

19. The computer readable storage medium of claim 18, wherein the control feedback loop output is based on:
the total budget and a period of time in which to spend the budget;
a portion of the total budget to spend for a specified portion of the period of time; and
the previous control feedback loop output.

20. The computer readable storage medium of claim 19, wherein the period of time is measured in units of days and wherein the specified portion of the period of time is one day.

21. The computer readable storage medium of claim 19, wherein the control feedback loop output is initialized based on a projected conversion ratio and a projected cost per click of the keyword.

22. The computer readable storage medium of claim 15, the operations further comprising:
receiving a maximum average return ratio from the content provider;
wherein the average return ratio is kept below the maximum average return ratio when calculating the bid for each keyword.

23. The computer readable storage medium of claim 15, wherein each conversion is weighted.
